(19) United States
(12) Patent Application Publication
(10) Pub. No.: US 2014/0278056 A1
(43) Pub. Date: Sep. 18, 2014

(54) SYSTEM AND METHOD FOR ROUTE-SPECIFIC SEARCHING

(71) Applicant: YP INTELLECTUAL PROPERTY LLC, Tucker, GA (US)

(72) Inventors: David Lothele Williams, Menlo Park, CA (US); Karan Nischol, Glendale, CA (US); Rohan Koduvayur Krishnan Chandran, Sunnyvale, CA (US); Timothy Towles, San Francisco, CA (US); Suresh Venkatraman, Palo Alto, CA (US); Jinpei Li, Cupertino, CA (US)

(21) Appl. No.: 13/831,288

(22) Filed: Mar. 14, 2013

(51) Int. Cl. G01C 21/34

(52) U.S. Cl. CPC G01C 21/3476
USPC 701/410; 701/533

(57) ABSTRACT

Systems and methods of route-specific searching are provided. Information about a first location and second location may be processed. The information about the second location may be from a user and may indicate a destination. A first route from the first location to the second location may be identified. A search query may be processed. Search results may be identified, and, a third location corresponding to the search result may be identified. A route from the first location to the third location to the second location may be determined. A deviation of the route with respect to the first route may be determined. A search result may be selected based on the deviation. A map may depict an area including the first location, the second location, and the third location. The route from the first location to the third location to the second location may be indicated.

### BACKGROUND OF THE DISCLOSURE

The present disclosure relates in general to searching and, more specifically, but not by way of limitation, to a system and method for route-specific searching.

As value, use, access, and demand corresponding to information continue to increase, consumers demand more of the products and services they use than ever before. Consumers expect that the companies to compete to provide them greater and greater levels of accuracy and more tailored service offerings. Companies configure and operate ever increasing numbers of computer systems to achieve this. Accessing sources of information that have traditionally been unavailable is now expected. With mobile computing devices, consumers continue to seek more and better information on-the-go.

As one example, fuel price information is one area of modern life where information available to consumers remains limited and under-utilized. Significant time, money, and effort revolve around fueling vehicles. Drivers of automobiles devote considerable money to filling up gas tanks. Oftentimes, drivers do not have the time to search for low gas prices and then end up settling for a convenient gas station, even though a higher price is charged at the pump, relative to some other gas stations in the vicinity. A driver's awareness of available gas price offerings may be limited. In some cases, a gas station that is known to provide competitive gas prices may well be out of the driver's way. And, the further one drives out of one's way to get the known best gas price, the more likely it is that the benefit of the price savings is outweighed by the costs in time, money, and effort devoted to the drive. Most consumers do not want to spend unnecessary time driving out of one's way for fuel or, generally, for other products and services.

### SUMMARY

In one embodiment, a system and a method for presenting fuel prices and corresponding fuel providers in a geographical area of interest to a user of a mobile computing device is disclosed. An information handling system accesses and retains fuel pricing information corresponding to a plurality of fuel providers. The information handling system may update the retained fuel pricing with fuel pricing information from a third party aggregator. A mobile application is made available for use on the mobile computing device. The information handling system interacts with the mobile computing device to provide fuel pricing information for use with the mobile application. Once initiated, the mobile application enables the user to view on the mobile computing device a map of either a vicinity about the user's current location or about another location of interest to the user. The user's current location may be determined automatically, for example, via use of a Global Positioning System (GPS) receiver associated with the mobile computing device, or through alternative means. The user may have the option of identifying another location interest by entering location information into the mobile computing device. A selected set of fuel prices available near the user's current location and/or the other location of interest is identified and categorized according to price. At least part of the selected set is displayed on the map and/or in a list view, along with the locations of the corresponding fuel providers. One or more of the fuel prices and corresponding locations may be displayed as the “best” prices or “good” prices nearby. One of the fuel prices and corresponding locations may be displayed as the best and nearest price.

In another embodiment, a system and a method for searching along a particular route for products and services is disclosed. For example, an end user may want to identify ATMs along a work commute. A mobile application may be provided that allows the user to search for and compare options along the particular route by viewing results in a map view or a list view. Listings and locations may be identified responsive to the user's query. The identified listings and locations may be ranked according to deviation, in time and/or driving distance, from the user's normal route. The application may provide detailed information—address, directions, maps, prices if applicable, hours of operation, etc. As an alternative to identifying a single route, the application could allow the user to only specify beginning and end points, and then compare alternative routes that would take the user closer to various options for the desired products or services. One beginning point could be the user's current location. The application could allow the user to save favorite routes and specific searches. The system and method may also include optimized ways to pull data fast. For example, an offline database of businesses may be used to pre-build and pre-load results, once a route is specified, anticipating a user's set of interests.

In one aspect, a method of route-specific searching relative to locations of interest to a user of a mobile computing device is provided. A mobile application configured to run on a mobile computing device may be supplied. Information about a first location may be processed. Information about a second location may be processed. The information about the second location may be from a user of the mobile computing device and may indicate a destination. A first route from the first location to the second location may be identified. An input from the user may be processed. The input may correspond to a search query. Responsive to the input, one or more search results may be identified, and, for at least one of the one or more search results, a third location may be identified, the third location corresponding to the search result; at least one route from the first location to the third location to the second location may be determined; and a deviation of the at least one route from the first location to the third location to the second location with respect to the first route from the first location to the second location may be determined. At least one of the one or more search results may be selected based at least in part on the deviation. The mobile application may be configured to cause display of a map on the mobile computing device, where the map depicts an area including the first location, the second location, and the third location, and to cause indication on the mobile computing device of the at least one route from the first location to the third location to the second location.

In another aspect, one or more non-transitory computer-readable storage media having computer-readable instructions for route-specific searching relative to locations of interest to a user of a mobile computing device may be provided. The instructions may be to cause one or more processors to perform a method that may include one or more of the following. Information about a first location may be processed. Information about a second location may be processed. The information about the second location may be from a user of the mobile computing device and may indicate a destination. A first route from the first location to the second location may be identified. An input from the user may be processed.

The input may correspond to a search query. Responsive to the input, one or more search results may be identified, and, for at least one of the one or more search results, a third location may be identified, the third location corresponding to the search result; at least one route from the first location to the third location to the second location may be determined; and a deviation of the at least one route from the first location to the third location to the second location with respect to the first route from the first location to the second location may be determined. At least one of the one or more search results may be selected based at least in part on the deviation. Display of a map on the mobile computing device may be caused. The map may depict an area including the first location, the second location, and the third location. Indication on the mobile computing device of the at least one route from the first location to the third location to the second location may be caused.

In yet another aspect, a mobile application system for route-specific searching relative to locations of interest to a user of a mobile computing device may be provided. A mobile application may be configured to run on a mobile computing device. The mobile application may include instructions to be stored on one or more storage media of the mobile computing device and to be executed by one or more processors of the computing device to perform one or more of the following. Information about a first location may be processed. Information about a second location may be processed. The information about the second location may be from a user of the mobile computing device and may indicate a destination. An input from the user may be processed. The input may correspond to a search query. Display of a map on the mobile computing device may be caused. The map may depict an area including the first location, the second location, and a third location. The third location may correspond to a search result identified responsive to the input. The search result may be selected based at least in part on a deviation of at least one route from the first location to the third location to the second location with respect to a first route from the first location to the second location. Indication on the mobile computing device of the at least one route from the first location to the third location to the second location may be caused.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 depicts a high-level block diagram of a system, in accordance with certain embodiments of the present disclosure.

FIG. 2 depicts a high-level block diagram of a system, in accordance with certain embodiments of the present disclosure.

FIG. 3 depicts a functional block diagram of a mobile computing device, in accordance with certain embodiments of the present disclosure.

FIG. 4 illustrates an example method of presenting fuel prices and corresponding fuel providers in a geographical area of interest to a user of a mobile computing device, in accordance with certain embodiments of the present disclosure.

FIG. 5 illustrates an example subprocess, in accordance with certain embodiments of the present disclosure.

FIG. 6 illustrates an example subprocess, in accordance with certain embodiments of the present disclosure.

FIG. 7 illustrates a graphical user interface, in accordance with certain embodiments of the present disclosure.

FIG. 8 shows a screenshot of a graphical user interface that may facilitate user entry of another location, saving information about a location, and/or retrieving saved information about a particular location, in accordance with certain embodiments of the present disclosure.

FIG. 9 shows a screenshot of a graphical user interface of a list view corresponding to search results, in accordance with certain embodiments of the present disclosure.

FIG. 10 shows a screenshot of a graphical user interface of a search menu, in accordance with certain embodiments of the present disclosure.

FIG. 11 shows a screenshot of a graphical user interface a list view corresponding to search results, in accordance with certain embodiments of the present disclosure.

FIG. 12 shows a screenshot of a graphical user interface a detailed information view, in accordance with certain embodiments of the present disclosure.

FIG. 13 shows a high-level block diagram of an embodiment of a system, in accordance with certain embodiments of the present disclosure.

FIG. 14 depicts an illustrative map, in accordance with certain embodiments of the present disclosure.

FIG. 15 shows a non-limiting example area of interest, in accordance with certain embodiments of the present disclosure.

FIG. 16 shows another non-limiting example area of interest, in accordance with certain embodiments of the present disclosure.

FIG. 17 depicts a non-limiting example of listings and/or locations being represented on a mobile computing device with corresponding indicators, in accordance with certain embodiments of the present disclosure.

FIG. 18 depicts a non-limiting example of indicating one or more routes from an origin to the location(s) to a destination, in accordance with certain embodiments of the present disclosure.

FIG. 19 illustrates an example method of route-specific searching relative to locations of interest to a user of a mobile computing device, in accordance with certain embodiments of the present disclosure.

FIG. 20 depicts a block diagram of an embodiment of a computer system, in accordance with certain embodiments of the present disclosure.

FIG. 21 depicts a block diagram of an embodiment of a special-purpose computer system, in accordance with certain embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Certain embodiments according the present disclosure enable a mobile computing device to be a local guide to fuel prices. With certain embodiments, a mobile application may be made available for execution on a mobile computing device. Various embodiments may include a specific purpose-based mobile application or a mobile application integrated with various other mobile application features. The mobile application executed on a mobile computing device provides for displaying, on a map and/or a list, indicators of fuel prices and fuel providers within a particular proximity. The proximity may be with respect to the current location of a mobile computing device or a location of interest entered by a user into the mobile computing device. In various embodiments, an area of interest proximal to the location may have any of various suitable forms. An area of interest may be a circular area with a particular radius with the location as the origin. The form of an area of interest may be more tailored to the specific needs of the user in some embodiments, e.g., by taking into account a user's direction of travel.

Some embodiments may categorize fuel prices according to price into two or more categories. By way of non-limiting example, fuel prices in the top 20 percent of the cheapest fuel price options available nearby may be indicated as the “Best;” fuel prices in the top 50 percent may be indicated as “Good;” and the two categories may be graphically distinguished on the display. Display of the fuel price options in an area proximal to the location may allow a user to compare the fuel options near the user's place of work, home, favorite locations, or other locations of interest. Thus, certain embodiments facilitate savings of money, time, and effort. Certain embodiments enable a user of a mobile computing device to store and/or label travel routes, locations, businesses, and other points of interest for ease of access. Some embodiments may provide directions to identified fuel providers, distances of travel to identified fuel providers, time estimates of travel to identified fuel providers, and/or a time of the last fuel price update. With some embodiments, fuel price information is gathered from an aggregator, processed, and selectively transferred to the mobile computing device over a network. Use of an aggregator may provide assurance of accuracy, consistency, currency, and comprehensiveness. Fuel price information may be captured, aggregated, and/or updated periodically or continually and/or in real time.

Certain embodiments enable a mobile computing device to also be a local guide to restaurants, hotels, ATMs, mechanics, Wi-Fi hotspots, and other businesses, service providers, and points of interest in the particular proximity. The results of searches for such points of interests may be displayed alongside the fuel prices and fuel providers within the particular proximity. This may allow a user to plan a trip based, at least in part, on where the cheapest fuel is located. Additional information regarding the fuel providers and/or other items of interest—such as ratings, reviews, business details, hours of operation, telephone number, and/or website address—may be available for access via the map and/or list display. Such access to local information affords an added measure of convenience to users, thereby helping users to take advantage of the value of the information.

Some embodiments provide for user selection of fuel type and/or grade as search criteria. In various embodiments, the fuel may be any suitable type of fuel, including, but not limited to, one or more of gasoline, diesel fuel, liquefied petroleum gas, compressed natural gas, liquefied natural gas, methanol, ethanol, biodiesel, electricity, and/or hydrogen. In the case of gasoline as the fuel type, for example, options for selecting regular, midgrade, and/or premium grade may be available with certain embodiments. Some embodiments may provide for selectivity, differentiation, and display of different fuel prices based on a method of payment—such as whether cash, credit, and/or debit is used. Thus, certain embodiments may allow a user to search for fuel providers that provide discounted prices for cash-paying customers. In addition or in the alternative, some embodiments may provide for selectivity, differentiation, and display of different fuel prices based on membership, registration, and/or affinity with a business. Thus, certain embodiments may allow a user to search for fuel providers that are membership-only providers, that provide rewards/discount programs, and/or that provide a specific fuel that the user deems more desirable than others (e.g., fuel that includes certain additives).

Various embodiments will now be discussed in greater detail with reference to the accompanying figures, beginning with FIG. 1.

FIG. 1 depicts a high-level block diagram of a content distribution system 100, in accordance with certain embodiments of the present disclosure. The system 100 allows sending and receiving information to one or more mobile computing devices 102 of one or more end users 103. As depicted, the mobile computing device 102 may be communicatively coupled or couplable to a network 104.

The network 104 may be any suitable means to facilitate data transfer in the system 100. In various embodiments, the network 104 may be implemented with, without limitation, one or more of the Internet, a wide area network (WAN), a local area network (LAN), a wireless local area network (WLAN), a metropolitan area network (MAN), a cellular network, such as through 4G, 3G, GSM, etc., another wireless network, a gateway, or any other appropriate architecture or system that facilitates the communication of signals, data, and/or message. The network 104 may transmit data using any suitable communication protocol. The network 104 and its various components may be implemented using hardware, software, and communications media such wires, optical fibers, microwaves, radio waves, and other electromagnetic and/or optical carriers; and/or any combination of the foregoing.

An information handling system 106 also may be communicatively coupled or couplable to a network 104. The information handling system 106 may facilitate searching of one or more information repositories in response to information received over the network 104 from the mobile computing devices 102. In various embodiments, the information handling system 106 may include any device or set of devices configured to send, receive, retrieve, detect, generate, compute, process, organize, categorize, qualify, store, display, present, handle, or use any form of information or data suitable for the embodiments described herein.

The information handling system 106 may include a single computing device or multiple computing devices, which may be implemented in or with a distributed computing and/or cloud computing environment. The information handling system 106 may include one or more processing resources communicatively coupled to one or more storage media, random access memory (RAM), read-only memory (ROM), and/or other types of memory. The information handling system 106 may include any one or combination of various input and output (I/O) devices, network ports, and display devices.

In certain embodiments, the information handling system 106 may be communicatively coupled or couplable to one or more data sources 108. The one or more data sources 108 may include any suitable source of data. In various embodiments, the one or more data sources 108 may include one or more of a database, a website, any repository of data in any suitable form, and/or a third party.

With some embodiments, the data sources 108 may include one or more aggregators 108(a). By way of non-limiting example, the aggregator 108(a) may include a third party gatherer of data on fuel prices, such as the Oil Price Information Service. In some such instances, the provision of the fuel pricing information from an aggregator 108(a) may accord a measure of reliability, consistency, comprehensiveness, thoroughness, and/or accuracy to the data gathered.

In certain embodiments, the data sources 108 may include and/or otherwise represent crowdsources 108(b). Data may be gathered from any suitable number of crowdsources 108(b)-1 to 108(b)-n. For example, fuel pricing information may be collected from a number of different devices operated by a number of different users and/or other entities, and thus may be considered to be “crowdsourced.” As an example, some fuel pricing information may originate from images captured by individual consumers at various fuel provider locations. Some fuel pricing information may originate from images captured by employees and/or owners of various fuel providers. In some instances, the end users 103 may utilize the mobile computing devices 102 to capture images for fuel prices information, by for example taking photos of the fuel prices listed at pumps and/or signs of fuel providers.

In various embodiments, the data from the one or more data sources 108 may be retrieved and/or received by the information handling system 106 via the network 104 and/or through any other suitable means of transferring data. According to certain embodiments, data may be actively gathered and/pulled from one or more data sources 108, for example, by accessing a third party repository or/and by “crawling” various repositories. The data pulled and/or pushed from the one or more data sources 108 may be made available by the information handling system 106 for user(s) 103 of the mobile computing device(s) 102. In alternative embodiments, data from the one or more data sources 108 may be made available directly to the mobile computing device(s) 102.

FIG. 2 shows a high-level block diagram of an embodiment of a system 100-2, in accordance with certain embodiments of the present disclosure. The system 100-2 may correspond to the system 100-1 of FIG. 1, but one embodiment of the information handling system 106 is shown in more detail. As depicted in FIG. 2, the information handling system 106 may include one or more processors 110 communicatively coupled to one or more memories 112, one or more fuel pricing information repositories 120, and one or more local listings information repositories 122. The one or more fuel pricing information repositories 120 may retain any fuel pricing information suitable for embodiments of this disclosure. Information retained in the one or more fuel pricing information repositories 120 may include, without limitation, fuel prices and fuel provider identification/location information. The one or more local listings information repositories 122 may retain any local listings information suitable for embodiments of this disclosure, such as business, product, and service information. In certain embodiments, the local listings information may correspond to directory information of the kind available via Yellow Pages services and the like.

The information handling system 106 may include a network interface 116 communicatively coupled to processor 110. Network interface 116 may include any suitable input/output module or other system/device operable to serve as an interface between the information handling system 106 and the network 104. The information handling system 106 may use the network interface 116 to communicate over the network 104 using any suitable transmission protocol and/or standard.

Various embodiments of the information handling system 106 may also include one or more local listings information engines 118, one or more fuel pricing information engines 119, and one or more location engines 117. The engines 118, 119, 120 may be stored in memory 112 and may include one or more software applications, executable with the processors 110, for receiving and processing data requests. The engines 118, 119, 120 may be configured to perform any of the steps of methods described in the present disclosure. By way of example without limitation, the local listings information engines 118 may receive a query from a user 103 of the mobile computing device 102, where the query is transferred over the network 104 to the information handling system 106. In certain embodiments, the query may have a packetized structure according to a packet protocol, and may include one or more search terms. Responsive to the query, the local listings information engines 118 may search, retrieve, modify, and/or cause transfer of particular information from the local listings information repository 122. In similar manner, the fuel pricing information engines 119 may search, retrieve, modify, and/or cause transfer of particular information from the fuel pricing information repository 120.

The location engine(s) 117 may use GPS coordinates, cellular tower triangulation techniques, Wi-Fi-based location information, carrier-provided location information, and/or other location determination systems to identify a location of the mobile computing device 102. The location engine(s) 117 may search, based at least partially on the location, one or more of the repositories 102, 122, and/or data source(s) 108, alone or in combination with one or more engines 118, 119. For non-limiting example, location engine(s) 117 and/or 120 may search the fuel pricing information repository 120 based on location information received from the mobile computing device 102. The search may yield fuel prices and fuel providers an area corresponding to the location information. Likewise, the engine(s) 118 and/or 120 may search the local listings information repository 122 for businesses, services, and/or products near the identified fuel providers.

FIG. 3 is a functional block diagram of a mobile computing device 102 with a mobile application 151 configured to run on the mobile computing device 102 and transform the mobile computing device 102 into a local guide, according to certain embodiments of the present disclosure. The mobile computing device 102 may be any portable device suitable for sending and receiving information over a network in accordance with embodiments described herein. For example without limitation, in various embodiments, the mobile computing device 102 may include one or more variously referenced as a mobile phone, a cellular telephone, a smartphone, a handheld mobile device, a tablet computer, a web pad, a personal digital assistant (PDA), a notebook computer, a handheld computer, a laptop computer, a vehicle computer, or the like.

As shown in FIG. 3, the mobile computing device 102 includes a display 130 and input elements 132 to allow a user to input information into the mobile computing device 102. By way of example without limitation, the input elements 132 may include one or more of a keypad, a trackball, a touchscreen, a touchpad, a pointing device, a microphone, a voice recognition device, or any other appropriate mechanism for the user to provide input. The mobile computing device 102 includes a memory 134 communicatively coupled to a processor 136 (e.g., a microprocessor) for processing the functions of the mobile computing device 102. The mobile computing device 102 may include at least one antenna 138 for wireless data transfer.

The mobile computing device 102 may also include a microphone 140 to allow a user to transmit his/her voice through the mobile computing device 102, and a speaker 142 to allow the user to hear voice communication, music, etc. In addition, the mobile computing device 102 may include one or more interfaces in addition to the antenna 138, e.g., a wireless interface coupled to an antenna. The communications interfaces 144 can provide a near field communication interface (e.g., contactless interface, Bluetooth, optical interface, etc.) and/or wireless communications interfaces capable of communicating through a cellular network, such as GSM, or through Wi-Fi, such as with a wireless local area network (WLAN). Accordingly, the mobile computing device 102 may be capable of transmitting and receiving information wirelessly through both short range, radio frequency (RF) and cellular and Wi-Fi connections.

Additionally, the mobile computing device 102 can be capable of communicating with a Global Positioning System (GPS) in order to determine to location of the mobile computing device 102. In the embodiment shown in FIG. 4, the antenna 138 may include a cellular antenna (e.g., for sending and receiving cellular voice and data communication, such as through a network such as a 3G or 4G network), and interfaces 144 may include one or more local communication interfaces. The antenna 138 may include GPS receiver functionality. In other embodiments contemplated herein, communication with the mobile computing device 102 may be conducted with a single antenna configured for multiple purposes (e.g., cellular, transactions, GPS, etc.), or with further interfaces (e.g., three, four, or more separate interfaces).

The mobile computing device 102 can also include at least one computer-readable medium 146 coupled to the processor 136, which stores application programs and other computer code instructions for operating the device, such as an operating system (OS) 148. The mobile application 151 may be stored in the memory 134 and/or computer-readable media 146. The computer-readable medium 146 can include a mapping application. In certain embodiments, the mapping application 146(a) can automatically run each time that a user accesses the mobile application 151. In some embodiments, the mapping application 146(a) can run continuously (e.g., in the background) or at other times, such as when the mobile application 151 is initiated by a user. With some embodiments, the mapping application 146(a) is separate from the mobile application 151. The mapping application 146(a) may have been pre-installed on the platform of the mobile computing device 102. In other embodiments, the mobile application 151 may include the mapping application 146(a). In some embodiments, the mobile application 151 and/or the mapping application 146(a) can include a customizable user interface (UI), which can be determined by the user's preferences through application-level programming. The mobile application 151 and/or the mapping application 146(a) can be used to display and manage maps of fuel provider locations and business/service locations, as well as to enter queries for directions to a specified location. For example, the mobile application 151 and/or the mapping application 146(a) may be configured to cause the display of the fuel price and fuel provider location indicators described herein.

The computer-readable medium 146 can also include an image-processing engine 146(b). The image-processing engine 146(b) can capture an image and compress the image in a format readable by a central processing server. The computer-readable medium 146 on the mobile computing device 136 can also include a locator query engine 146(c), which allows a user to enter a word or phrase to locate an item, location, business, services, etc. With some embodiments, the locator query engine 146(c) is separate from the mobile application 151. In other embodiments, the mobile application 151 may include the locator query engine 146(c).

The mobile computing device 136 can additionally include an integrated camera 150, capable of capturing images and/or video, and output elements 152. In certain embodiments, the mobile computing device 136 may include a non-transitory computer-readable storage medium, e.g., memory 134, for storing images captured with the camera 150. In alternative embodiments, the mobile computing device 136 receives image data from an image capture device that is not integrated with the mobile computing device 136 and stores those images on the aforementioned non-transitory storage medium.

FIG. 4 illustrates an example method 400 of presenting fuel prices and corresponding fuel providers in a geographical area of interest to a user of a mobile computing device 102, in accordance with certain embodiments of the present disclosure. According to one embodiment, the method 400 may begin at step 402. Teachings of the present disclosure may be implemented in a variety of configurations that may correspond to the system 100. As such, the order of the steps comprising the method 400 may be shuffled in any suitable manner and may depend on the implementation chosen. Moreover, while the following steps may be separated for the sake of description, it should be understood that certain steps may be performed simultaneously or substantially simultaneously.

The method 400 may allow for user identification of search criteria at any one or more of various suitable points in the process flow, according to various embodiments. By way of example without limitation, the user may identify search criteria (e.g., fuel type, fuel grade, and/or selectivity, differentiation, and display of different fuel prices based on a method of payment, and/or membership, registration, and/or affinity with a business) prior to, contemporaneous with, and/or after any one or more of the method steps. In some embodiments, the search criteria may be set as a default for the mobile application; and, with some embodiments, the mobile application may automatically perform one or more of the method steps.

At step 402, a mobile application 151, which is configured to run on a mobile computing device 102, is provided. The mobile application 151 may be provided in any suitable way. For non-limiting example, the mobile application 151 may be made available from the information handling system 106 or any website for download to the mobile computing device 102; alternatively, it may be pre-installed on the mobile computing device. The mobile application 151 may be stored in the memory 134 and/or computer-readable media 146.

At step 404, a first set of fuel pricing information stored in a repository is processed. The first set of fuel pricing information may include a first set of fuel prices for a fuel offered by any number of fuel providers. The fuel pricing information may include, but is not limited to, prices for one or more particular types and/or grades of fuel and any suitable identifications of the fuel providers (e.g., gas stations) providing the fuels at those prices. In some embodiments, the fuel pricing may also include the addresses or other location information of the fuel providers. The fuel may be any suitable type of fuel, including, but not limited to, one or more of gasoline, diesel fuel, liquefied petroleum gas, compressed natural gas, liquefied natural gas, methanol, ethanol, biodiesel, electricity, and/or hydrogen.

In some embodiments, step 404 is performed responsive to a user selection of search criteria for fuel pricing information. In some embodiments, step 404 is performed responsive to user initiation of the mobile application and/or a search criteria default. In some embodiments, step 404 is performed responsive to a user selection of search criteria for fuel pricing information. In some embodiments, step 404 is performed prior to and/or independent of any user selection of search criteria for fuel pricing information.

In some embodiments, the repository may include one or more of the data sources 108. Thus, with some embodiments, the fuel pricing information may be sourced from a third party aggregator, such as the Oil Price Information Service. In some such instances, the provision of the fuel pricing information may accord a measure of reliability, consistency, comprehensiveness, thoroughness, and/or accuracy to the data gathered. The information handling system 106 may pull and/or push the fuel pricing information from the one or more data sources 108 in any suitable way. The fuel pricing information may, in certain embodiments, be stored in the fuel pricing information repository 120, which may be a database in some instances. However, the fuel pricing information may be stored elsewhere and/or in other ways, or may not be stored, depending on the implementations chosen. Moreover, in certain embodiments, step 404 may be performed at, by, and/or with the mobile computing device 102.

At step 406, a second set of fuel pricing information may be processed in some embodiments. The second set of fuel pricing information may include one or more of the first set of fuel prices offered by the first plurality of fuel providers. With some embodiments, step 406 may be performed by the information handling system 106. The information handling system 106 may, for example, consolidate the first set of fuel pricing information from the one or more data sources 108 with fuel pricing information previously stored by the information handling system 106. Accordingly, the fuel pricing information previously stored may be updated, as necessary, with the first set of pricing information. The result of the update and consolidation may be the second set of fuel pricing information. As such, the second set of fuel pricing information may be an updated and current set of fuel pricing information, and the second set of fuel pricing information may include one or more of the first set of fuel prices offered by the first plurality of fuel providers. In certain embodiments, step 406 may be performed at, by, and/or with the mobile computing device 102 and mobile application 151. Certain embodiments may not include step 406; for example, the method may proceed from step 404 directly to step 408, with certain subsequent steps performed with respect to the first set of fuel pricing information instead of the second set of fuel pricing information.

At step 408, information about a first location may be processed at, by, and/or with the mobile computing device 102 and/or the information handling system 106. The information may be automatically gathered and may correspond to the location of the mobile computing device 102. For example, the mobile computing device 102 may include one or more GPS receivers 138, one or more accelerometers, one or more magnetometers, and/or one or more gyroscopes that enable determination of its position based on data provided by these components and/or signals received by these components, such as received satellite signals. In certain embodiments, triangulation methods (e.g., triangulation based on cellular towers, Wi-Fi-based location, carrier-provided location, or any suitable cloud-based location method, service, source, and/or technique) may be employed to identify the location of the computing device. In the case of GPS, the GPS receiver 138 may facilitate the identification of GPS coordinates.

In addition or in the alternative to automatically-gathered location information, a user may enter location information with the mobile computing device 102. The user may identify any location interest by entering location information into the mobile computing device. The user may enter an address, a partial address, a city, a zip code, a location keyword, or any suitable location-indicating information. As noted previously, the user may enter location information corresponding to a place of work, the user's home, or other favorite locations.

At step 410, an area proximal to the first location may be identified. The area proximal to the first location may correspond to a search area. In other words, the area may the prime area in which to search for fuel prices and fuel providers. According to some embodiments, the information handling system 106 identifies the area proximal to the first location; according to other embodiments, the mobile application executed on the mobile computing device 102 identifies area proximal to the first location.

At step 412, a subset of fuel pricing information out of the second set (and/or the first set) of fuel pricing information may be processed. The subset of fuel pricing information may correspond to a third set of fuel prices offered by a third plurality of fuel providers located within the area proximal to the first location. The subset of fuel pricing information may be a complete set of all fuel price options in the area. Alternatively, the subset may be a selected set of those fuel options in the area, the selectivity being based on any suitable criterion. According to some embodiments, the information handling system 106 identifies and retrieves the subset for transfer to the mobile computing device 102; according to other embodiments, the mobile application executed on the mobile computing device 102 identifies and/or retrieves the subset. In certain embodiments, the subset of fuel pricing information may be from the first set of fuel pricing information instead of the second set of fuel pricing information.

At step 414, the subset of fuel pricing information may be categorized according to price. Each of the third (or second) set of fuel prices may be identified as corresponding to one of two or more price categories. By way of non-limiting example, one or more of the fuel prices and corresponding locations may be displayed as the “best” prices or “good” prices nearby; fuel prices in the top 20 percent of the cheapest fuel price options available nearby may be indicated as the “best”; fuel prices in the top 40 percent may be indicated as “Good.” Certain embodiments may provide for one of the fuel prices and corresponding locations being categorized as the best price nearest to the location of interest. According to various embodiments, step 414 is performed by the information handling system 106 and/or the mobile application 151 executed on the mobile computing device 102.

At step 416, a map may be displayed on the mobile computing device 102 to depict a vicinity about the first location. The vicinity about the first location may include at least part of the area proximal to the first location. At step 418, one or more fuel prices and one or more locations corresponding to the first price category may be indicated on the map. At step 420, one or more fuel prices and one or more locations corresponding to the second price category may be indicated on the map. The two categories may be graphically distinguished on the display by one or more of text (e.g., “Best,” “Good”), figures (e.g., stars), and/or color (e.g., green for the best prices, orange for the good prices). Of course, it should be understood that the thresholds of 20% and 50% are merely exemplary. Moreover, in certain embodiments, the thresholds are user-adjustable.

Any suitable threshold and any suitable number of thresholds may be implemented in accordance with various embodiments of this disclosure. For example, at step 422, one or more fuel prices and one or more locations corresponding to a third price category may be indicated on the map. The third category may correspond to those fuel options not falling into either of the first and second category.

Additionally, the method may enable the mobile computing device to also be a local guide to restaurants, hotels, ATMs, mechanics, Wi-Fi hotspots, and other businesses, service providers, and points of interest in the particular proximity. The mobile application may allow for such searches at any one or more suitable points of the method, according to various embodiments. And, the results of searches for such points of interests may be displayed alongside the fuel prices and fuel providers within the particular proximity As will be described further herein, additional information regarding the fuel providers and/or other items of interest—such as ratings, reviews, business details, hours of operation, telephone number, and/or website address—may be available for access via the map and/or list display.

FIG. 5 illustrates an example subprocess 410 corresponding to step 410 of method 400, in accordance with certain embodiments of the present disclosure. In various embodiments, an area of interest proximal to the location may have any of various suitable forms. An area of interest near the location may be a circular area a particular radius around the location with the location as the origin. The form of an area of interest may be more tailored to the specific needs of the user. For example, if the user is at a workplace, it may be more appropriate to search area between the workplace and the user's home. In such circumstances, an area of interest taking the form of a semi-circle, triangle, funnel-like shape, or other suitable shape generally extending from the workplace toward the home may be most convenient for the user so that the user does not go away the user's usual way.

One non-limiting example of the subprocess 410 may begin with a transition from step 408 to step 410-1. At step 410-1, it may be determined whether the user entered a location or whether the process flow is based on the user's current (e.g., GPS-based) location. In the case of the user having entered a location, the proximal area to be searched may lie between the user's current location and the user-entered location, as indicated by step 410-2. For instance, if the user-entered location corresponds to the user's home and the user's current location is in the same general vicinity, a primary search may target an area between the current location and the user's home location. If the primary search yields insufficient results, the search area may be expanded.

In the case of the user not having entered a location, it may be determined at step 410-3 whether the user is moving, as indicated by movement of the mobile computing device 102. To make that determination, information about a second location may be processed in certain embodiment. Additional location information about the mobile computing device 102 may be automatically gathered, for example, via GPS coordinates. Alternatively, the user may indicate that the user is traveling in some cases via input to the mobile computing device 102.

If the mobile computing device 102 is moving, then a direction of travel may be determined, as indicated by step 410-4. The information handling system 106 and/or the mobile application 151 may be adapted to determine a direction of travel based, at least in part, on the multiple locations identified. As step 401-5, with a direction of travel determined, the area of interest for searching may be restricted to an area generally forward of the first location and the second location, relative to the direction of travel.

As indicated by step 410-6, a speed of travel may be gauged in some embodiments. For example, the information handling system 106 and/or the mobile application 151 may be adapted to determine a speed of travel based, at least in part, on correlating time information with the multiple locations identified. As step 401-7, with a speed of travel determined, the selection of the search area may be based at least partially on the speed. As one non-limiting example, a semi-circular area forward of the user may be appropriate for lower rates of speed (e.g., at walking speed). Likewise, lesser radii may be appropriate for lower rates of speed. Conversely, a semi-circular area and lesser radii may not be appropriate for higher rates of speed (e.g., for a user traveling at a high rate of speed in a vehicle on a highway, a semicircular search may require backtracking by the user). A triangular or funnel-like shape, e.g., generally extending outward from the user's current location along the user's direction of travel may be most convenient for the user to minimize deviation from the user's route.

As indicated by step 410-8, in the case of no user movement, it may be determined whether one of the user's previously identified favorite locations is in the general vicinity of the user's location. If so, an area between the current and favorite locations may be searched, as indicated by step 410-9. For example, if the user is in the general vicinity of the user's home, but not currently at home, it may be more appropriate to search an area between the user's current location and the user's home. And finally, as indicated by step 410-10, absent other considerations, an area of interest near the user's current location may be a circular area having a particular radius around the location, with the user's current location as the origin.

According to some embodiments, the information handling system 106 identifies the search area; according to other embodiments, the mobile application executed on the mobile computing device 102 identifies the search area. In certain embodiments, the search area may be iterative modified dependent upon the results of one or more searches. For example, an initial search for an initial search area in rural location may yield too few or no results; and the search area may consequently be expanded to increase the results.

FIG. 6 illustrates an example subprocess 518′ corresponding to steps 518, 520, 522 of the method 500, in accordance with certain embodiments of the present disclosure. The subprocess 518′ may allow for presenting the search results in a manner that is visually digestible and useful to a user. One non-limiting example of the subprocess 518′ may begin with a transition from step 516 to step 518-1. At step 518-1, a scope of the map that is displayed on the mobile computing device 92 may be processed. The extent of the displayed map may include all or only part of the area proximal to the first location. Stated otherwise, the displayed map may present a “zoomed-in view” of the search area or a “zoomed-out view” of the search area. In such cases, varying groups of the search results may be displayed in varying views of the map. At step 518-2, a first group of fuel providers located nearest to the center of the map may be identified. At step 518-3, it may be determined whether any of the fuel price indicators would visually overlap on the map when displayed at their corresponding fuel provider locations. In the case of an overlap, the conflicting fuel price indicators may be ranked according to price, as indicated at step 518-4. As indicated with step 518-5, a fuel price indicator may overlap on top of a fuel price indicator having a higher price, but not vice versa. In that way, the better price option has greater visibility to the user.

At step 518-6, prices from the fuel providers in the first group located nearest to the center of the map may be displayed, with any conflicts of overlapping icons resolved. In one non-limiting example, a group of 10 prices for 10 fuel providers may be displayed near the center of the map. Ten may be a visually digestible number for certain mobile computing devices. However, other numbers of prices may be chosen for display on a given device. And, at step 518-7, minimized indicators for all other fuel providers located on the map may be displayed. In this manner, the center of the map may be provided as a focal point for the user, with a limited number of prices displayed.

The user may wish to adjust the map, as indicated at step 518-8. The user may, for example, want pan over in one direction or another to adjust the viewable area of town. Such an adjustment will adjust the center of the displayed map. Thus, at step 518-9, a second group of fuel providers located nearest to the center may be identified. As indicated by steps 518-10 through 518-14, the second group may be ranked and displayed in the same manner as the first group, with all other fuel providers located on the map being displayed with minimized indicators.

FIG. 7 illustrates a graphical user interface that may be used in implementations of certain embodiments of the present disclosure. FIG. 7 shows a screenshot 700 of a mobile application called Gas Guru shown on a mobile computing device. The graphical user interface (GUI) displays a map 702 of a particular vicinity corresponding to a user-entered location 704, which in the example depicted is San Francisco, Calif. Some embodiments, such as the one depicted, may allow a user to zoom into, zoom out of, and/or pan to a particular vicinity by any suitable means. In the example depicted, the user has adjusted the display to show a vicinity near San Francisco, Calif., by touching the touchscreen in a conventional manner. A selectable icon 707 may be provided to allow user entry of another location. FIG. 8, for example, shows a screenshot 800 that may facilitate user entry of another location, saving information about a location, and/or retrieving saved information about a particular location.

Referring again to FIG. 7, the screenshot 700 indicates search results for a fuel type and grade 706, which corresponds to regular gas in this example. A selectable icon 708 is included on the touchscreen for user to select a fuel type and/or grade. In the case of gasoline as the fuel type, for example, options for selecting regular, midgrade, and/or premium grade may be available by selecting icon 708.

The screenshot 700 indicates search results 710 that correspond to a first category of a top 20% of a set of fuel prices. The search results 710 may be indicated on the map 702 with icons placed to indicate corresponding fuel provider locations and graphically distinguished as “BEST” with green highlights. Each of the icons for search results 710 may be selectable by the user to display additional information corresponding to a particular fuel provider. An icon 712 in the non-limiting example illustrated shows additional information about a specific fuel provider, responsive to a user selection. Though FIG. 7 shows icon 712 in a user-selected stated, it may be noted that FIG. 8 shows a corresponding screenshot 800 with the icon in an unselected state. Referring again to FIG. 7, further and/or different information about the specific fuel provider may be available upon further selection by the user. In the embodiment shown, the additional information shown (i.e., gas station name, “GasCo,” and partial address, “12354 Albert St., San Franc . . . ”) has been display responsive to a user selection of a selectable icon 714. The icon 714 indicates a best nearby price and provides an option to select and identify the location of a nearest fuel provider providing the selected fuel at a best price.

The screenshot 700 indicates search results 716 that correspond to a second category of a top 50% of a set of fuel prices. The search results 716 may be indicated on the map 702 with icons placed to indicate corresponding fuel provider locations and graphically distinguished as “GOOD” with orange highlights. Each of the icons for search results 716 may also be selectable to display additional information corresponding to a particular fuel provider.

The screenshot 700 indicates search results 718 that correspond to a third category of a set of fuel prices, a category for those fuel price options that do not fall into the first or second categories. The search results 718 may be indicated on the map 702 with icons placed to indicate corresponding fuel provider locations and graphically distinguished with prices bordered in gray. A selectable icon 720 may be provided to adjust the display so as to center the map 702 about a user's current location, which may be automatically determined (e.g., based on GPS functionality) as previously described.

A selectable icon 722 may be provided to allow user selection of a list view of the search results 710, 716, and/or 718. FIG. 9 shows a screenshot 900 of a list view corresponding to the search results 710, 716, and/or 718. As the non-limiting example illustrates, the list view may include fuel provider information 502 (e.g., fuel provider name and address), recency information 504 indicating a last time when the price information was updated for a particular fuel provided, and/or distance information 506 indicating a travel time from a user's current or entered location to a given fuel provider. A selectable icon 508 may allow for sharing of fuel provider information via social media.

Referring to the screenshot 800 of FIG. 8, which includes search results on a map that is substantially similar to the screenshot 700 of FIG. 7, it may be noted that only ten prices 804 are indicated on the map 802. While other numbers of prices may be chosen for display on a given device, ten may be a visually digestible number for certain mobile computing devices.

Referring again to FIG. 7, a selectable icon 724 may be provided to allow the mobile computing device to also be a local guide to restaurants, hotels, ATMs, mechanics, Wi-Fi hotspots, and other businesses, service providers, and points of interest in the particular proximity. FIG. 10 shows a screenshot 1000 corresponding to some such embodiments. The results of searches for such points of interests may be displayed alongside the fuel prices and fuel providers within the particular proximity. FIG. 11 shows a screenshot 1100 corresponding to some such embodiments, where the results are provided in a list view. The results may also be displayed in a map view with some embodiments. This may allow a user to plan a trip based, at least in part, on where the cheapest fuel is located. Additional information regarding the fuel providers and/or other items of interest—such as ratings, reviews, business details, hours of operation, telephone number, and/or website address—may be available for access via the map display. FIG. 12 shows a screenshot 1200 corresponding to certain embodiments showing such additional information.

FIG. 13 shows a high-level block diagram of an embodiment of a system 100-3, in accordance with certain embodiments of the present disclosure. The system 100-3 may correspond to certain variations of the systems 100-1, -2. In FIG. 13, an end user 103 may use a mobile computing device 102 to submit a search request over the network 104 to a server 1310 and/or to receive search results. The server(s) 1310 may utilize engine(s) 1317 to process the search request and present search results based on the information stored in the local listings information repository 122 and/or a route information repository 1334. The engine(s) 1317 may include location engine 117, the local listing information engine 118, and/or a route analytics engine 1332. While engines, repositories, and other components are described separately herein, it should be appreciated that the components may be combined and/or implemented differently in any combination to provide certain features in various embodiments. In various embodiments, different processes running on one or more shared computers may implement some of the components.

The server 1310 may include an application server 1310(a) and/or other types of servers, such as a web server, instant messaging gateway, and/or telephone gateway (not shown) to interface with different servers. Some embodiments may use one type of server 1310, such as application server 1310(a), to receive the search request and another type of server 1310 to provide the search results. Some embodiments may use different types of servers 1310 to service different types of mobile computing devices 102. The servers 1310 may run on the same or separate computers. In one embodiment, there may be one or more layers of application servers between the server 1310 and the local listings information repository 122 to process the business logic and data access of rich client applications. Alternatively, application servers, such as the application servers 1310(a), may be integrated with the servers 1310. The present disclosure is not limited to a particular type of connections among the servers 1310, the location engine 117, the local listings information engine 118, the local listings information repository 122, the route information repository 1334, the route analytics engine 1332, and other modules, such as a voice recognition system (not shown). In some embodiments, the location engine 117, the local listings information engine 118, the local listings information repository 122, the route information repository 1334, the route analytics engine 1332, and other modules, are servers communicating with the server 1310.

Different embodiments may implement the local listings information repository 122 and/or the route information repository 1334 in different ways. For example, one or more data processing systems may store the information about routes 1330, locations 1326, and listings 1324. For example, one or more relational or object oriented databases, or flat files on one or more computers or networked storage devices, may store the information about the routes 1330, the locations 1326 and the listings 1324. In some embodiments, a centralized system stores the information about the routes 1330, the locations 1326 and the listings 1324; alternatively, a distributed system, such as a peer to peer network, or the Internet, may store the information about the routes 1330, the locations 1326 and the listings 1324.

Listings 1324 may include information regarding one or more of businesses or people, such as restaurants, car dealers, retailer locations, service providers, gas stations, parking lots, plumbers, and the like, and may have street addresses or other location parameters, such as longitude and latitude coordinates, stored as corresponding locations 1326. The listings 1324 may include addresses, telephone numbers, advertisements, announcements, and/or events, etc. For example, the listing 1324 may be related to a public event that has a time associated with a location 1326. The locations 1326 may be part of the listings 1324, or associated with the listings 1324. In one embodiment, the listings 1324 include information related to business entities at corresponding locations 1326. The entities may be businesses or people. Some of the entities may be advertisers who pay advertisement fees to promote their listings 1324. Some of the entities may be non-advertisers who have free listings 1324. In certain embodiments, the listings 1324 may be accessible to the public or to registered members. In some embodiments, the listings 1324 may include amenities of given entities, such as restrooms, dining services, concierge services, various guest services, etc., which may be specified with a search query or presented as user-selectable options for refinement of a search query.

In some embodiments, a mobile application is made available for use on the mobile computing device 102 that allows the end user 103 to submit a route-specific search request. In some embodiments, the mobile computing device 102 includes a web browser which allows the end user 103 to submit a route-specific search request. In certain embodiments, the servers 1310 may provide and/or facilitate a user interface for route-specific searches by, for example, providing static web pages, dynamic web pages, and/or web services, etc. In certain embodiments, the mobile computing device 102 may provide the search request via other communication channels, such as email, short message service (SMS), instant messaging (IM), telephone connection, etc. For example, the mobile computing device 102 may provide the search request to an email gateway via email, or to an IM gateway via instant messaging, or to a telephone gateway via a telephone call. In some embodiments, the end user 103 may use one mobile computing device 102 to submit the search request and another mobile computing device 102 to receive the search results. For example, the user 103 may submit the search request via an SMS message through one mobile computing device 102, and receive the search results at another mobile computing device 102 via email. For example, the user may submit the search request via voice through one mobile computing device 102 and receive the search results via a web page at another mobile computing device 102 or at the same mobile computing device 102.

FIG. 14 depicts an illustrative map 1400, in accordance with certain embodiments of the present disclosure. The map 1400 depicts various roads 1402 in an example location. The roads 1402 may represent the major highways in the location, while it is to be understood that other streets are omitted from FIG. 14 for the sake of clarity. In certain embodiments, the map 1400 may correspond to a map display on the mobile computing device 102.

The end user 103 may identify one or more locations of interest. The end user 103 may identify a location that indicates an origin 1404. The end user 103 may identify a location that indicates a destination 1406. The end user 103 may indicate the location(s) by any suitable means, including but not limited to, entering text and/or selecting a point on a map displayed on the mobile computing device 102 by way of a touchscreen, cursor, or other selector tool. In some embodiments, the origin may correspond to the user's current location.

The user's current location may be determined automatically in certain embodiments. For example, the location engine 117 may determine the location of the mobile computing device 102 based on a connection point the mobile computing device 102 used to access the network 104 (e.g., based on the location of a wireless network access point, a base station of a cellular communication system, or a connection point to a wired network). In some embodiments, the mobile computing device 102 automatically determines its current position (e.g., via a satellite positioning system, or a cellular positioning system) and transmits the determined or estimated position to the server 1310 with or separately from the search request. The mobile computing device 102 could provide the position in response to a request from the location engine 117.

In various embodiments, the location engine 117 and/or the route analytics engine 1332 may identify an area of interest proximal to one or more of the origin 1404, destination 1406, and/or route(s) therebetween. The area of interest could be predetermined in some embodiments. In other embodiments, the area of interest could be determined with processing the origin 1404, the destination 1406, and/or the search query.

FIG. 15 shows one non-limiting example area of interest 1408. The area of interest 1408 could encompass the quickest route between the origin 1404 and 1406. In various embodiments, an area of interest could include a circular area about the origin 1404, a circular area about the destination 1406, a circular area between the origin 1404 and the destination 1406, and/or a circular area encompassing the origin 1404 and the destination 1406. An area of interest may not be circular but could be defined by any shape. The shape of an area of interest may be irregular, as in the example area of interest 1408. An area of interest may be restricted to between the origin 1404 and the destination 1406; or, the area of interest may not be so restricted such that the origin 1404 and/or destination 1406 are not outer limits.

The form of an area of interest may be more tailored to the specific needs of the user in some embodiments, e.g., by taking into account a user's direction of travel. In the example area of interest 1408, the quickest route from the origin 1404 to the destination 1406 may be encompassed, however, the route may not be the quickest for a return trip from the destination 1406 to the origin 1404. Thus, an area of interest for the return trip may ecompass a different route. As another example of taking into account a user's direction of travel, the area of interest may be a triangular or funnel-like shape, e.g., generally extending outward from the user's current location along the user's direction of travel may be most convenient for the user to minimize deviation from the user's route. Such an area of interest may appropriate for relatively long and/or straight stretches of highway.

An area of interest may encompass and/or be defined by/with respect to a metropolitan area, business district, and/or the like. An area of interest may be defined at least in part by political, physical, and/or topographical map characteristics.

An area of interest may be defined at least in part by deviation. For example, the deviation could be a max distance from one or more routes between the origin and the destination. The deviation could be quantified in distance as the crow flies (i.e., the shortest distance between the origin and the destination), driving distance, and/or driving time. For example, the area of interest 1408 may exclude an area 1410 that, while being close to the main highway, would involve relatively greater deviation in driving time and distance. There may be no exits from the highway leading to the area 1410. Or, there may be exits leading to the area 1410, but returning to the highway may be difficult to a lack of nearby on-ramps and/or a lack of accessibility due to the street layout in that area 1410 and/or because of street closures due to construction and the like.

An area of interest could exclude certain locales for any of a variety of reasons. For example, a high-crime area could be excluded. For example, the area of interest 1408 may exclude an area 1412 because it has a high rate of crime relative to other areas nearby or because of any suitable reason. An area with known high prices could be excluded. For example, gas stations around an airport may be known to offer higher gas prices relative to other gas stations further from the airport, to take advantage of drivers needing to refuel prior to returning rental vehicles. Thus, the area of interest could exclude an area close to the airport responsive to a search for gas stations. Such exclusions could be user-selectable and, once specified by the end user 102, could be stored as a user preference. Moreover, in some embodiments, any of the options for customizing an area of interest could be presented to the end user 102 as user-selectable options, with a user selection(s) possibly stored as a user preference(s).

An area of interest may be determined/refined prior to the end user 103 submitting a search query. For example, an area of interest may be determined based on one or more of the origin being identified, the destination being identified, and/or previously stored/loaded information. With some embodiments, the area of interest may be determined/refined responsive to the end user 103 submitting a search query.

Responsive to the search query, the local listings information engine 118 may identify one or more listings 1324 stored on the repository 122. The area of interest may be used as a search filter. Accordingly, the subset of identified one or more listings 1324 may have corresponding locations 1326 in the area of interest. If no results are identified for a particular area of interest, the area of interest could be iteratively expanded in an attempt to capture one or more results.

For example, in the event that a search in the area of interest 1408 yields no results, a different area of interest may identified and used as a search filter. FIG. 16 shows one non-limiting example area of interest 1409 that could be used in that event. The area of interest 1409 could encompass the next quickest routes between the origin 1404 and 1406. The area of interest 1409, like area of interest 1408, could still take into account various factors, such as excluding area 1412. If no results are identified for area of interest 1409, the iterative expansion of the area of interest could continue in order to identify listings 1324 as search results.

The local listings information engine 118 and/or route analytics engine 1332 may rank the identified listings 1324 according to the search request. For example, the identified listings 1324 may be ranked according to relevance with respect to the search query, particularly if many listings 1324 are identified as responsive to the query. The identified listings 1324 may be ranked according to distance from one or more of the origin, the destination, and/or one or more routes between the origin and the destination, the distance being quantified as the crow flies or driving distance. The identified listings 1324 could be ranked according to deviation in driving time from one or more routes between the origin and the destination, such as the quickest and/or shortest route between the origin and the destination. One or more of such methods could be presented to the end-user as user-selectable options and, once specified by the end user 102, could be stored as a user preference. One or more of such methods could be pre-set as a default.

In certain embodiments, the identified listings 1324 and/or locations 1326, or a subset thereof, may be indicated to the mobile computing device 102. For example, a list view and/or a map view of the identified listings 1324 and/or locations 1326, or a subset thereof, may be presented to the end user 103. And the listings 1324 and/or locations 1326 may be presented according to a ranking.

The route analytics engine 1332 may determine one or more routes 1330 from the origin 1404 to one or more listings 1324/locations 1326 to the destination 1406. In some embodiments, the determination may be made prior to any presentation of results to the end user 103. In some embodiments, the determination may be made responsive to a user selection of a listing 1324/location 1326.

The origin 1404 could be considered a first location, the destination a second location 1406, and the identified location 1326 a third location. In addition to the case of a single identified location 1326, embodiments could include multiple interim locations 1326. Thus, the search query and routes 1330 could include multiple stops between the origin and destination.

The route analytics engine 1332 may estimate driving times of the one or more routes 1330, including interim driving times between each of the locations along the routes 1330. The driving times may be estimated considering current traffic information. Current traffic information could be provided with a mapping tool of the mobile computing device 102 in some embodiments. Current traffic information could be gathered by the server 1310 in some embodiments, for example, through crawling or a linked site.

The route analytics engine 1332 may determine driving distances of the one or more routes 1330, including interim driving distances between each of the locations along the routes 1330. In some embodiments, the driving distances may be determined by any suitable facility, which may include a mobile application on the mobile computing device 102. For example, the mobile applicant may invoke a mapping application resident on the mobile computing device 102 to facilitate the determination.

With various embodiments, any of the criteria used to determine the routes 1330 may be indicated on the mobile computing device 102. For example, the deviation (in terms of driving time and/or distance) of the routes 1330 with respect to a direct route between the origin and destination may indicated for the end user 203 to view, either automatically or responsive to selection of a user-selectable option. The end user 103 may have the option of modifying the routes 1330 by identifying another location interest. Additionally, any addition listing information described herein may displayed automatically or responsive to selection of a user-selectable option.

FIG. 17 depicts a non-limiting example of listings 1324 and/or locations 1326 being represented on the mobile computing device 102 with corresponding indicators 1414, 1416. The ranking (e.g., according to one or more relevance, deviation in driving time, and/or deviation in driving distance) could be reflected by the indicators 1414, 1416. The indicator 1414, for example, may be identified as the “Best” to indicate the highest ranked result. The indicators 1416 may be identified as “Good” to indicate a second category of results. Other indicators could of course be used, such as others described previously. For example, the business name(s) may be displayed. Further information could be displayed. For example, deviation information such as that indicated by 1418 could be displayed automatically or responsive to user selection of the indicator 1414.

In some embodiments, the end user 103 may be presented with selectable options to choose one or more listings 1324 and/or locations 1326, such as in the example of FIG. 17 with the indicators 1414, 1416 representing listings 1324/locations 1326. Responsive to a selection, one or more routes 1330 from the origin to the location(s) 1326 to the destination may be presented to the end user 103. In some embodiments, one or more routes 1330 from the origin 1404 to the location(s) 1326 to the destination 1406 may be presented without and/or prior to a user selection. For example, in the case of a small number of listings 1324 and locations 1326 being identified, one or more routes 1330 from the origin 1404 to the location(s) 1326 to the destination 1406 may be presented for user selection. Thus, the user selection may identify a particular listing/location from the small number of possibilities. For example, in the case of a single listing 1324 and location 1326 being identified, one or more routes 1330 from the origin to the location(s) to the destination may be presented without user selection.

Thus, representations of the one or more routes 1330 may be displayed on the mobile computing device 102. The mobile application may be configured to cause display of a map on the mobile computing device 102 such that the map depicts an area including the first location (e.g., the origin 1404), the second location (e.g., the destination 1406), and the third location (corresponding to listing 1324/location 1326), and the routes 1330 therebetween. In some embodiments, the single best route 1330 is indicated, the best route being that with the least deviation with respect to the quickest route between the origin and destination, for example. Alternative route(s) 1330 may be displayed responsive to selection of a user-selectable option. In some embodiments, the multiple routes 1330 could be displayed. The multiple routes 1330 could be graphically distinguished on the map to identify the best route. The means of graphical distinction could include one or more of text, figures, dimension, and/or color. The one or more routes 1330 could also be displayed in other ways, such as list view.

FIG. 18 depicts a non-limiting example of indicating one or more routes 1330 from the origin 1404 to the location(s) 1326 to the destination 1406, as may be indicated to a user 103 on mobile computing device 102. In the depicted example, the location 1326 is represented by indicator 1414; the routes 1330 are represented by indicators 1420, 1422. As such, the user 103 is presented with two options for routes. The routes may be graphically distinguished in any way. As depicted, indicator 1420 is distinguished from indicator 1422. The indicator 1420 may correspond to the best route; that is, the quickest route and the route with the least deviation. The indicators 1420, 1422 may be user-selectable such that further information may be presented upon selection.

In various embodiments, the servers 1310 may provide the listings 1324/locations 1326 with links to detail information pages of the listings 1324, such as a directions, business hours, etc. The servers 1310 may provide user interfaces for the users to rate the listings 1324, provide reviews, view reviews from other users, etc. The servers 1310 may provide user interfaces to make reservations or to make purchases via the listings 1324. The servers 1310 may provide user interfaces to allow the end user 103 to plan events using the listings 1324, to store or bookmark selected listings, to share the listings with friends, etc. The servers 1310 can track various different types of user interactions with the listings to determine or estimate the level of user interest in the listings.

Certain embodiments may employ pre-loading of data in any of various ways. Various embodiments may receive and/or process the inputs of origin, destination, and search query in various sequential orders. A set of listing and/or route information may be identified once any of the inputs is received and/or processed. The set of identified information may be refined in view of one or more subsequently received/processed inputs. For example, once a user's current location is identified, which may occur automatically upon initialization of the mobile application in some embodiments, listing and/or route information in the vicinity may be identified by the listing information engine 118. In the case of a user identifying an origin different from the user's current location, listing and/or route information in the vicinity of the origin may be may be identified by the listing information engine 118. Once a destination is identified, listing and/or route information in the vicinity of the destination may be identified by the listing information engine 118. Once both an origin and a destination is identified, listing and/or route information in the vicinity of both may be identified/refined. Likewise, a set of information may be identified based on a search query and then refined based on origin/destination inputs. Listing and/or route information may be pre-loaded on the mobile computing device 102 in any of the foregoing instances. In certain embodiments, the servers 1310 may track various different types of user interactions with the listings 1324 to determine or estimate the level of user interest in the listings 1324 and pre-load the mobile computing device 102 with data according to the interest.

The local listing information repository 122 may store listings 1324/locations 1326 from previous searches by the end user 103. The route information repository 1334 may store routes 1330 previously provided to the end users 103. In some embodiments, the mobile computing device 102 stores the listings 1324, locations 1326, and/or routes 1330. In some embodiments, both the mobile computing device 102 and the repositories 122, 1334 store the listings 1324, locations 1326, and/or routes 1330 from previous searches. In some embodiments, when there is a data communication connection between the mobile computing device 102 and the repositories 122, 1334, the mobile computing device 102 and repositories 122, 1334 may synchronize their copies of the listings 1324, locations 1326, and/or routes 1330 for the end user 103. With certain embodiments, additional listing and/or route information corresponding to vicinties involved with previous searches may be pre-loaded on the mobile computing device 102, even though the end user 103 has not yet searched for the additional listing and/or route information.

FIG. 19 illustrates an example method 1900 of route-specific searching relative to locations of interest to a user 103 of a mobile computing device 102, in accordance with certain embodiments of the present disclosure. According to one embodiment, the method 1900 may begin at step 1902. Teachings of the present disclosure may be implemented in a variety of configurations that may correspond to the system 100-1, -2, -3. As such, the order of the steps comprising the method 1900 may be shuffled in any suitable manner and may depend on the implementation chosen. Moreover, while the following steps may be separated for the sake of description, it should be understood that certain steps may be performed simultaneously or substantially simultaneously.

A mobile application 151, which is configured to run on a mobile computing device 102, may be provided in any suitable way as previously described. At step 1902, information about a first input may be processed. The first input may correspond to a first location that is an origin. As previously described, the user 103 may indicate the first location, or it may be automatically determined. At step 1904, it may be determined whether an option of pre-loading data is selected. For example, a flag may have been previously set select the option. If pre-loading is indicated, it may be determined whether there is any relevant previous information, as indicated by step 1906. Relevancy of previous information may be based on the user, the mobile computing device, and/or the first location. The previous information may have stored on the mobile computing device and/or a remote repository. The previous information may include location information, listing information, route information, user selections, and/or user preferences.

In the case of previous information being identified, an area of interest may be determined based at least in part on the previous information, as indicated by step 1908. If there is no previous information, a default area of interest may be determined, as indicated by step 1910. In either case, the process may proceed to step 1912, where listings/locations in the area of interest may be identified. The process may proceed to step 1914.

As indicated by step 1914, information about a second input may be processed. The second input may correspond to a second location that is a destination. At step 1916, an area of interest may be determined based at least in part on the first and second inputs. Or, in the case of an area of interest having been previously determined, the area of interest may be refined per the second input. At step 1918, it may be desirable to identify listings/locations. Particularly if a set of listings/locations has already been identified as in step 1912, the set may be modified based at least in part on the refinements to the area of interest per the second input.

As indicated by step 1920, a third input may be processed. The third input may correspond to a search query from the user. At step 1922, search results responsive to the search query may be identified. As indicated by step 1924, it may be desirable to present the search results to the user. The search may need clarification/refinement from the user, as in the case of an unclear query, no relevant results being found, and/or ambiguous results being found, for example. At step 1926, one or more routes may be identified with respect to the origin, the destination, and one or more identified listings/locations. At step 1928, relevance and/or deviation of the identified listings/locations may be determined. At step 1930, the identified listings/locations may be ranked according to relevance and/or deviation. At step 1932, the identified listings/locations may be displayed to the user, particularly if there a multiple listings/locations. However, even if only a single listing/location is identified, it may be indicated it to the user without indicating routes to the listing/location. At step 1934, one or more routes may be indicated to the user. As discussed previously, the routes may be displayed per relevance/deviation with only the best route displayed or with the best route distinguished from other identified routes displayed. At step 1936, any suitable information may be displayed responsive to user selection, as discussed previously.

Referring next to FIG. 20, an exemplary environment with which embodiments may be implemented is shown with a computer system 2000 that can be used by a designer 2004 to design, for example, electronic designs. The computer system 2000 can include a computer 2002, keyboard 2022, a network router 2012, a printer 2008, and a monitor 2006. The monitor 2006, processor 2002 and keyboard 2022 are part of a computer system 2026, which can be a laptop computer, desktop computer, handheld computer, mainframe computer, etc. The monitor 2006 can be a CRT, flat screen, etc.

A designer 2004 can input commands into the computer 2002 using various input devices, such as a mouse, keyboard 2022, track ball, touch screen, etc. If the computer system 2000 comprises a mainframe, a designer 2004 can access the computer 2002 using, for example, a terminal or terminal interface. Additionally, the computer system 2026 may be connected to a printer 2008 and a server 2010 using a network router 2012, which may connect to the Internet 2018 or a WAN.

The server 2010 may, for example, be used to store additional software programs and data. In one embodiment, software implementing the systems and methods described herein can be stored on a storage medium in the server 2010. Thus, the software can be run from the storage medium in the server 2010. In another embodiment, software implementing the systems and methods described herein can be stored on a storage medium in the computer 2002. Thus, the software can be run from the storage medium in the computer system 2026. Therefore, in this embodiment, the software can be used whether or not computer 2002 is connected to network router 2012. Printer 2008 may be connected directly to computer 2002, in which case, the computer system 2026 can print whether or not it is connected to network router 2012.

With reference to FIG. 21, an embodiment of a special-purpose computer system 104 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 2026, it is transformed into the special-purpose computer system 104.

Special-purpose computer system 104 comprises a computer 2002, a monitor 2006 coupled to computer 2002, one or more additional user output devices 2130 (optional) coupled to computer 2002, one or more user input devices 2140 (e.g., keyboard, mouse, track ball, touch screen) coupled to computer 2002, an optional communications interface 2150 coupled to computer 2002, a computer-program product 2105 stored in a tangible computer-readable memory in computer 2002. Computer-program product 2105 directs system 104 to perform the above-described methods. Computer 2002 may include one or more processors 2160 that communicate with a number of peripheral devices via a bus subsystem 2190. These peripheral devices may include user output device(s) 2130, user input device(s) 2140, communications interface 2150, and a storage subsystem, such as random access memory (RAM) 2170 and non-volatile storage drive 2180 (e.g., disk drive, optical drive, solid state drive), which are forms of tangible computer-readable memory.

Computer-program product 2105 may be stored in non-volatile storage drive 2180 or another computer-readable medium accessible to computer 2002 and loaded into memory 2170. Each processor 2160 may comprise a microprocessor, such as a microprocessor from Intel® or Advanced Micro Devices, Inc.®, or the like. To support computer-program product 2105, the computer 2002 runs an operating system that handles the communications of product 2105 with the above-noted components, as well as the communications between the above-noted components in support of the computer-program product 2105. Exemplary operating systems include Windows® or the like from Microsoft® Corporation, Solaris® from Oracle®, LINUX, UNIX, and the like.

User input devices 2140 include all possible types of devices and mechanisms to input information to computer system 2002. These may include a keyboard, a keypad, a mouse, a scanner, a digital drawing pad, a touch screen incorporated into the display, audio input devices such as voice recognition systems, microphones, and other types of input devices. In various embodiments, user input devices 2140 are typically embodied as a computer mouse, a trackball, a track pad, a joystick, wireless remote, a drawing tablet, a voice command system. User input devices 2140 typically allow a user to select objects, icons, text and the like that appear on the monitor 2006 via a command such as a click of a button or the like. User output devices 2130 include all possible types of devices and mechanisms to output information from computer 2002. These may include a display (e.g., monitor 2006), printers, non-visual displays such as audio output devices, etc.

Communications interface 2150 provides an interface to other communication networks and devices and may serve as an interface to receive data from and transmit data to other systems, WANs and/or the Internet 2018. Embodiments of communications interface 2150 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 2150 may be coupled to a computer network, to a FireWire® bus, or the like. In other embodiments, communications interface 2150 may be physically integrated on the motherboard of computer 2002, and/or may be a software program, or the like.

RAM 2170 and non-volatile storage drive 2180 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 2170 and non-volatile storage drive 2180 may be configured to store the basic programming and data constructs that provide the functionality of various embodiments of the present invention, as described above.

Software instruction sets that provide the functionality of the present invention may be stored in RAM 2170 and non-volatile storage drive 2180. These instruction sets or code may be executed by the processor(s) 2160. RAM 2170 and non-volatile storage drive 2180 may also provide a repository to store data and data structures used in accordance with the present invention. RAM 2170 and non-volatile storage drive 2180 may include a number of memories including a main random access memory (RAM) to store of instructions and data during program execution and a read-only memory (ROM) in which fixed instructions are stored. RAM 2170 and non-volatile storage drive 2180 may include a file storage subsystem providing persistent (non-volatile) storage of program and/or data files. RAM 2170 and non-volatile storage drive 2180 may also include removable storage systems, such as removable flash memory.

Bus subsystem 2190 provides a mechanism to allow the various components and subsystems of computer 2002 communicate with each other as intended. Although bus subsystem 2190 is shown schematically as a single bus, alternative embodiments of the bus subsystem may utilize multiple busses or communication paths within the computer 2002.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method of route-specific searching relative to locations of interest to a user of a mobile computing device, the method comprising:
supplying a mobile application configured to run on a mobile computing device;
processing information about a first location;
processing information about a second location, wherein the information about the second location is from a user of the mobile computing device and indicates a destination;
identifying a first route from the first location to the second location;
processing an input from the user, wherein the input corresponds to a search query; and
responsive to the input:
identifying one or more search results; and
for at least one of the one or more search results:
identifying a third location, the third location corresponding to the search result;
determining at least one route from the first location to the third location to the second location; and
determining a deviation of the at least one route from the first location to the third location to the second location with respect to the first route from the first location to the second location;
selecting the at least one of the one or more search results based at least in part on the deviation;
wherein the mobile application is configured to:
cause display of a map on the mobile computing device, wherein the map depicts an area including the first location, the second location, and the third location; and
cause indication on the mobile computing device of the at least one route from the first location to the third location to the second location.

2. The method of claim 1, wherein the first location comprises:
an automatically-gathered location of the mobile computing device; and/or
a user-entered location gathered from a user of the mobile computing device.

3. The method of claim 2, wherein the automatically-gathered location of the mobile computing device comprises a position of the mobile computing device identified with one or more of a receiver included with the mobile computing device and/or location information from a source external to the mobile computing device.

4. The method of claim 1, wherein the deviation comprises a difference in distance between a first distance corresponding to the first route from the first location to the second location and a second distance corresponding to the at least one route from the first location to the third location to the second location.

5. The method of claim 1, wherein the deviation comprises a difference in time between a first time corresponding to the first route from the first location to the second location and a second time corresponding to the at least one route from the first location to the third location to the second location.

6. The method of claim 1, wherein the mobile application is further configured to:
cause presentation of one or more selectable icons that corresponds to the third location; and
cause indication of additional information corresponding to third location, responsive to a user selection of one of the one or more selectable icons.

7. The method of claim 1, wherein the indication of the at least one route from the first location to the third location to the second location is selectable so that, responsive to a user selection, additional information indicated, the additional information corresponding to the at least one route from the first location to the third location to the second location.

8. One or more non-transitory computer-readable storage media having computer-readable instructions for route-specific searching relative to locations of interest to a user of a mobile computing device, the instructions to cause one or more processors to perform a method, the method comprising:
processing information about a first location;
processing information about a second location, wherein the information about the second location is from a user of the mobile computing device and indicates a destination;
identifying a first route from the first location to the second location;
processing an input from the user, wherein the input corresponds to a search query; and
responsive to the input:
identifying one or more search results;
for at least one of the one or more search results:
identifying a third location, the third location corresponding to the search result;
determining at least one route from the first location to the third location to the second location; and
determining a deviation of the at least one route from the first location to the third location to the second location with respect to the first route from the first location to the second location;
selecting the at least one of the one or more search results based at least in part on the deviation;
causing display of a map on the mobile computing device, wherein the map depicts an area including the first location, the second location, and the third location; and
cause indication on the mobile computing device of the at least one route from the first location to the third location to the second location.

9. The one or more non-transitory computer-readable storage media of claim 8, wherein the first location comprises:
an automatically-gathered location of the mobile computing device; and/or
a user-entered location gathered from a user of the mobile computing device.

10. The one or more non-transitory computer-readable storage media of claim 9, wherein the automatically-gathered location of the mobile computing device comprises a position of the mobile computing device identified with one or more of a receiver included with the mobile computing device and/or location information from a source external to the mobile computing device.

11. The one or more non-transitory computer-readable storage media of claim 8, wherein the deviation comprises a difference in distance between a first distance corresponding to the first route from the first location to the second location and a second distance corresponding to the at least one route from the first location to the third location to the second location.

12. The one or more non-transitory computer-readable storage media of claim 8, wherein the deviation comprises a difference in time between a first time corresponding to the first route from the first location to the second location and a second time corresponding to the at least one route from the first location to the third location to the second location.

13. The one or more non-transitory computer-readable storage media of claim 8, wherein the method further comprises:
causing presentation of one or more selectable icons that corresponds to the third location; and
causing indication of additional information corresponding to third location, responsive to a user selection of one of the one or more selectable icons.

14. The one or more non-transitory computer-readable storage media of claim 8, wherein the indication of the at least one route from the first location to the third location to the second location is selectable so that, responsive to a user selection, additional information indicated, the additional information corresponding to the at least one route from the first location to the third location to the second location.

15. A mobile application system for route-specific searching relative to locations of interest to a user of a mobile computing device, the mobile application system comprising:
a mobile application configured to run on a mobile computing device, wherein the mobile application includes instructions to be stored on one or more storage media of the mobile computing device and to be executed by one or more processors of the computing device to:
process information about a first location;
process information about a second location, wherein the information about the second location is from a user of the mobile computing device and indicates a destination;
process an input from the user, wherein the input corresponds to a search query;
cause display of a map on the mobile computing device, wherein the map depicts an area including the first location, the second location, and a third location, wherein the third location corresponds to a search result identified responsive to the input, the search result selected based at least in part on a deviation of at least one route from the first location to the third location to the second location with respect to a first route from the first location to the second location; and
cause indication on the mobile computing device of the at least one route from the first location to the third location to the second location.

16. The mobile application system of claim 15, wherein the first location comprises:
an automatically-gathered location of the mobile computing device; and/or
a user-entered location gathered from a user of the mobile computing device.

17. The mobile application system of claim 16, wherein the automatically-gathered location of the mobile computing device comprises a position of the mobile computing device identified with one or more of a receiver included with the mobile computing device and/or location information from a source external to the mobile computing device.

18. The mobile application system of claim 15, wherein the deviation comprises a difference in distance between a first distance corresponding to the first route from the first location to the second location and a second distance corresponding to the at least one route from the first location to the third location to the second location.

19. The mobile application system of claim 15, wherein the deviation comprises a difference in time between a first time corresponding to the first route from the first location to the second location and a second time corresponding to the at least one route from the first location to the third location to the second location.

20. The mobile application system of claim 15, the instructions to be executed by one or more processors of the computing device further to:
cause presentation of one or more selectable icons that corresponds to the third location; and
cause indication of additional information corresponding to third location, responsive to a user selection of one of the one or more selectable icons.
